(19) United States
(12) Patent Application Publication
(10) Pub. No.: US 2009/0063320 A1
(43) Pub. Date: Mar. 5, 2009

(54) Electronic Lending System Method and Apparatus for Loan Completion

(76) Inventors: Shawna Kerry Powell, Alpharetta, GA (US); Raymond Gerber, Duluth, GA (US)

Correspondence Address: PHILIP H. BURRUS, IV, 460 Grant Street, Atlanta, GA, 30312, US

(21) Appl. No.: 11/856,791

(22) Filed: Sep. 18, 2007

Related U.S. Application Data
(60) Provisional application No. 60/969,115, filed on Aug. 30, 2007.

(51) Int. Cl. G06Q 40/00

(52) U.S. Cl. 705/35

(57) ABSTRACT

A method and system for completing on-line electronic installment loan application (101) completion includes requesting verification documentation from a borrower. Specifically, upon receipt of a partially completed on-line loan application, an analyzer (107) checks personal information, financial information, or banking information provided by the prospective borrower. Where anomalies are detected, a request generator (110) generates a prompt for the user to submit various verification documentation. A document generation utility (111) optionally generates a fax cover sheet, which may include an identifying barcode, that the prospective borrower may used to fax back the verification documentation. Such documentation is received by a facsimile transmission receiver (109).

### CROSS REFERENCE TO PRIOR APPLICATIONS

This application claims priority and benefit under 35 U.S.C. §119(e) from U.S. Provisional Application No. 60/969,115, filed Aug. 30, 2007.

### BACKGROUND

1. Technical Field

This invention relates generally to a method and system for facilitating due diligence in completing an electronic transaction, and more specifically to a method and system for requesting verification documentation in response to receiving an on-line loan application.

2. Background Art

The increasing popularity of the Internet and the World Wide Web has led to an increase of on-line services. By way of example, before Internet commerce one needed to visit a bank or other financial institution to obtain a loan. Now, however, one may apply for installment loans, lines of credit, and even home mortgages on-line.

While the process of obtaining a loan may be completed on-line, lenders still must perform due diligence analyses on prospective borrowers. For instance, prior to loaning prospective borrower money, the lender may wish to verify the borrower's name, age, occupation, employer, credit history, and so forth. Sometimes, the on-line process makes this due diligence more difficult because the lender is unable to meet the prospective borrower face to face.

To further complicate matters, due diligence analysis often requires verification of borrower information via paper documentation. For example, a lender may wish to verify that a prospective borrower is gainfully employed. The lender may desire to do this to ensure that the borrower is financially capable of repaying the loan. Unfortunately, verification of employment generally requires that the lender either call or write the employer, either of which is labor intensive and time consuming. Alternatively, the lender may examine a document, such as a pay stub. However, in on-line lending processes this is cumbersome, as the prospective borrower must mail the pay stub in after completing an on-line application. Many prospective borrowers forget to complete such a step. Additionally, mailing is slow. Many borrowers need money sooner rather than later.

There is thus a need for a system to facilitate convenient delivery of verification documentation in response to receiving a transaction request, such as an on-line loan application.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a system for facilitating on-line loan application completion in accordance with the invention.

FIG. 2 illustrates one screen shot from an automated loan offering system in accordance with embodiments of the invention.

FIG. 3 illustrates one screen shot from an automated loan offering system in accordance with embodiments of the invention.

FIG. 4 illustrates one screen shot from an automated loan offering system in accordance with embodiments of the invention.

FIG. 5 illustrates one screen shot from an automated loan offering system in accordance with embodiments of the invention.

FIG. 6 illustrates one screen shot from an automated loan offering system in accordance with embodiments of the invention.

FIG. 7 illustrates one embodiment of a method for facilitating on-line loan application completion in accordance with the invention.

FIG. 8 illustrates one embodiment of a method for performing validation analysis on an on-line loan application system in accordance with embodiments of the invention.

FIG. 9 illustrates various types of verification documentation in accordance with embodiments of the invention.

FIG. 10 illustrates an alternate embodiment of a method for facilitating on-line loan application completion in accordance with the invention.

FIG. 11 illustrates one embodiment of a fax cover sheet to be printed with a request for verification documentation in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to facilitating completion of electronic transactions, such as on-line loan applications, by making it convenient for prospective borrowers to return verification documentation. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of loan application completion by request of verification documentation as described herein. As such, these functions may be interpreted as steps of a method. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Lenders generally want to verify a borrower's personal information, credit history, and financial information prior to making a loan. This is traditionally done by lender investigation—the lender will call the borrower's employer and verify employment, call the borrower's bank and verify account status, and so forth. While this system works well in a face to face process, the process is difficult to complete with respect to automated systems, such as on-line loan applications. Embodiments of the present invention provide a way to perform such verification analysis in conjunction with an automated, electronic, on-line loan application system. In one embodiment, the methods and systems described herein select a certain number of verification documents to be submitted by the prospective borrower. The methods and system prompt the user for this verification documentation, which in one embodiment is selected based upon extracted data from the on-line loan application. Upon prompting the borrower for these verification documents, in one embodiment the method and system also delivers a fax cover sheet having a barcode associated with the loan application. The borrower simply faxes back the requested documentation with the fax coversheet, which is routed into a database and attached to the loan application by way of the bar code.

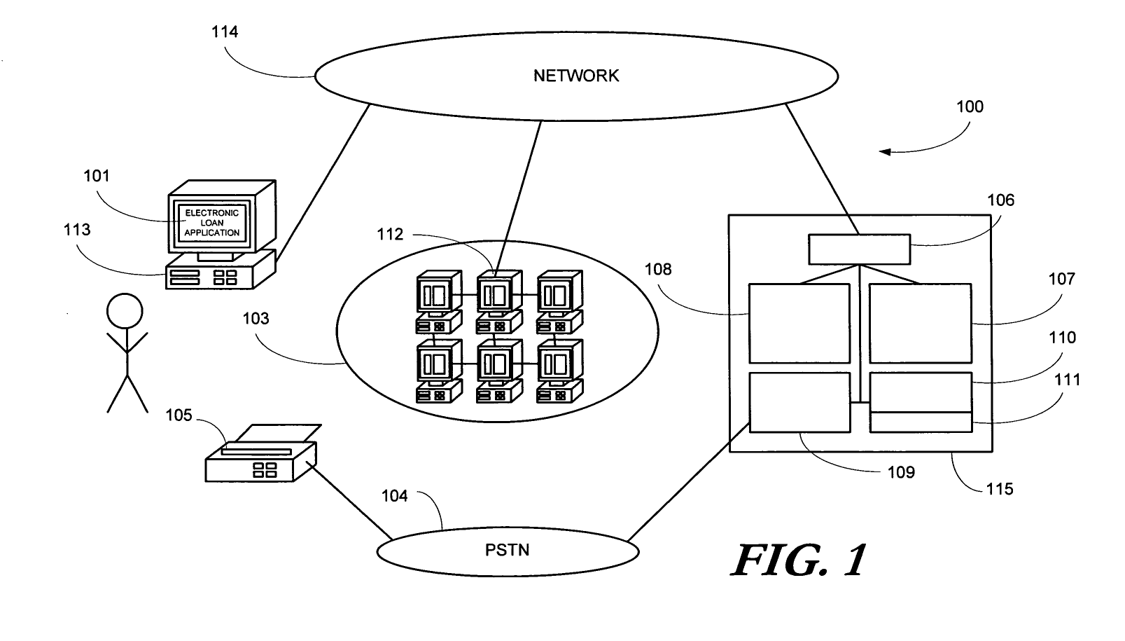

Turning now to FIG. 1, illustrated therein is one embodiment of a system 100 for use in completing on-line electronic loan application processes in accordance with the invention. The system is configured for operation across a network 114 between a server 115 and a client terminal 113. When a prospective borrower completes an on-line loan application 101 on the client terminal 113, the on-line loan application is transferred across the network 114 to the server 115. The server 115 then analyzes the application, determines whether verification documentation is required, and if so, prompts the user for such verification documentation on the client terminal 113. In one embodiment, the server 115 further delivers an electronic fax cover sheet to the client terminal 113. The borrower is then able to print the fax cover sheet, and transmit it back to the lender's system and server 115 by way of a fax machine 105 and a telephone network 104, such as the public switched telephone network (PSTN).

The server 115 includes an electronic interface 106. The electronic interface 106 may be integrated with the server 115, such as a network connection or communication port. Alternatively, the electronic interface 106 may be separate from the server 115 and coupled thereto as a communication interface. The electronic interface 106 is configured to deliver the on-line electronic loan application 101 to the client terminal 113. In one embodiment, the on-line electronic loan application 101 includes a request for personal information, bank information, and financial information. The electronic interface 106 is further configured to receive at least a partially completed on-line loan electronic application from the client terminal 113. A partially completed on-line loan application is an on-line electronic loan application 101 that has been populated with at least some data by the prospective borrower.

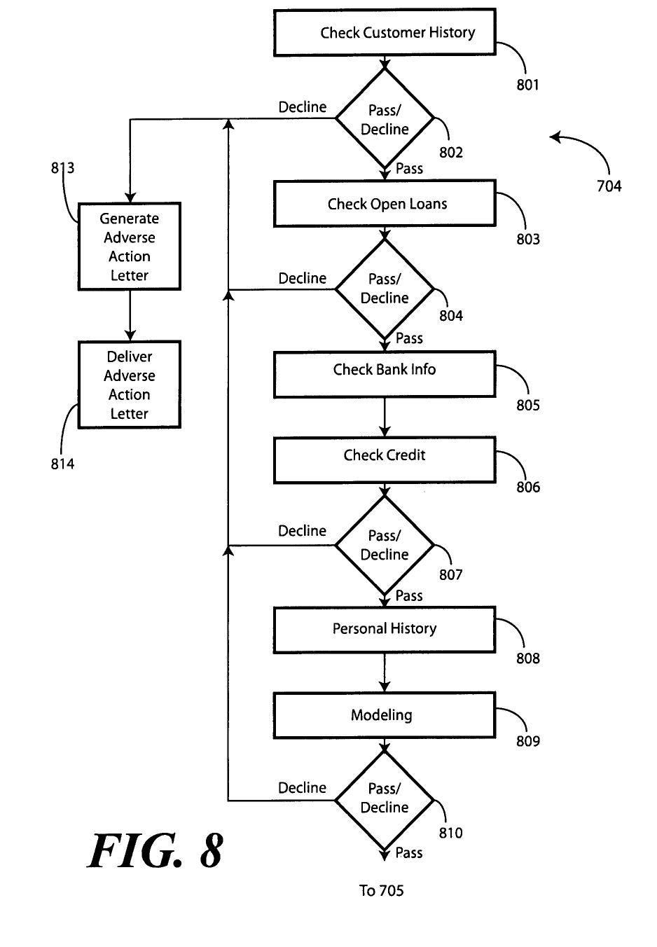

The server also includes an analyzer 107. The analyzer 107, which may comprise operable code stored within a memory of the server 115 and running on a processor of the server 115, is configured to perform a verification analysis on data extracted from the partially completed on-line electronic loan application 101. This verification analysis, one embodiment of which will be described in greater detail with respect to FIG. 8, checks a prospective borrower's personal data, financial data, and bank data. Other extracted data elements may also be checked.

By way of example, in one embodiment the prospective borrower includes personal information when completing the on-line electronic loan application 101. Upon receipt of the on-line electronic loan application 101, the analyzer may be configured to request corresponding information from a third party 103, such as a credit bureau. The credit bureau may then provide information, such as a credit report, from its server 112. The analyzer 107 is configured to check the personal information by comparing that information with the credit report pulled from the credit bureau server 112. Where a match is found, the information is passed. Where a mismatch is found, an anomaly is flagged.

Where anomalies are flagged, verification documentation is generally required from the borrower. As will be seen below, lenders may purposefully set anomaly flags—even where the analyzer 107 fails to detect mismatches in data—to accommodate specific lending rules or to control application backlog.

Once an anomaly is flagged, a request generator 110, operable with the server 115, is configured to deliver, electronically, over the network 114 on the client terminal 113, a prompt requesting verification documentation. The verification data requested generally relates to the extracted data, although this need not necessarily be the case. In the personal information example above, where the mismatch is detected, the lender may request a recent utility bill or telephone bill bearing an indication of the home address as verification that the borrower lives where they claim. As such, the request generator 110 would generate a prompt on the client terminal 113 alerting the borrower that such a verification document is required to complete the on-line electronic loan application 101.

To aid the borrower in submitting the verification documentation, a document generation utility 111, operable with the server 115, is configured to deliver a fax coversheet to the client terminal 113. In one embodiment, the fax cover sheet comprises an indication of the verification documentation. For instance, the memo field of the fax cover sheet might list “_ utility bill” or “_ phone bill,” thereby allowing the borrower to check which one will be submitted. Additionally, the fax coversheet may include the borrower's name, address, and telephone number, as well as the lender's name, address, and fax number. In one embodiment, the fax coversheet includes a bar code that facilitates electronic delivery by the server's facsimile transmission receiver 109.

Once the borrower has received the request for verification documentation, the borrower may print the associated fax coversheet. The borrower then completes the on-line loan application process by filling out the fax coversheet, attaching the required verification documentation. The borrower then transmits the documentation to the lender through a fax machine 105—or other comparable device, such as a facsimile application running in the client terminal 113. In one embodiment, the facsimile transmission passes through a telephone network 104 to the lender's system.

A facsimile transmission receiver 109, operable with the server 115, is configured to receive facsimile transmissions. Such facsimile transmissions may be received from the network 114, a telephone network 104, or other communication system. The facsimile transmission receiver is configured to convert the facsimile transmissions to electronic documents, and to write the electronic documents to the database 108. The database 108, which is coupled to the server 115, is configured to storing on-line electronic loan application data. In one embodiment, the facsimile transmission receiver 109 is configured to associate the incoming facsimile transmission with a particular on-line electronic loan application 101 stored in the database 108 by way of the barcode on the facsimile cover sheet. The barcode is thus used as a sorting criterion.

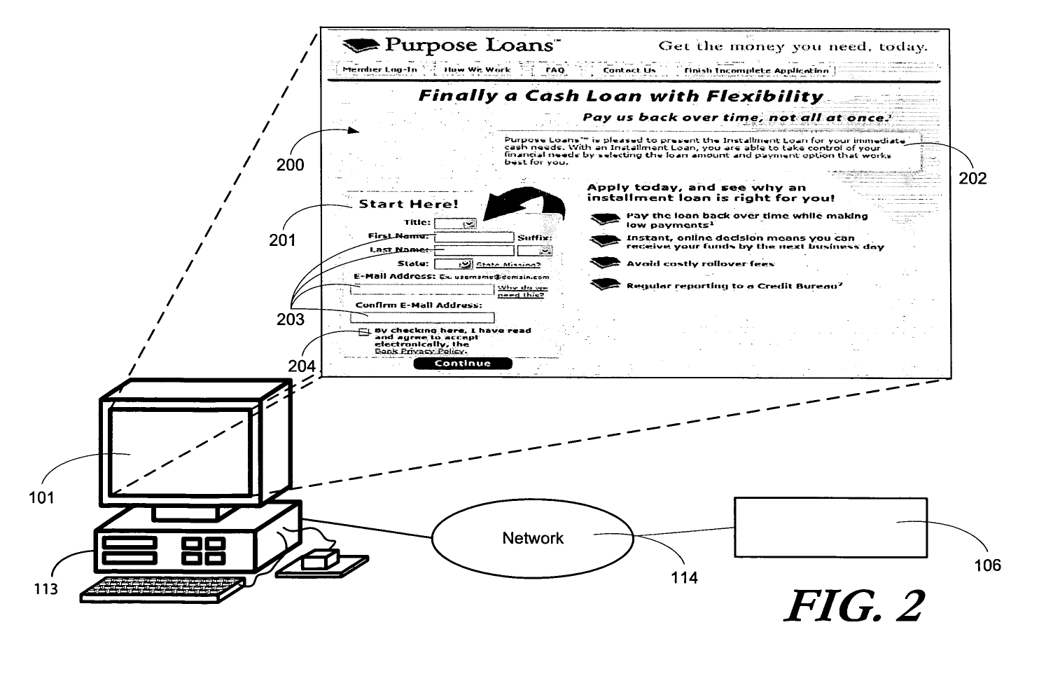

Turning now to FIG. 2, illustrated therein is one embodiment of the on-line electronic loan application 101 from which data may be extracted to determine whether verification documentation is required from the borrower in accordance with the invention. As noted above, a customer request, such as an on-line electronic loan application 101, may require a follow-up activity—such as verification—prior to completion. FIGS. 2-6 illustrate screen shots associated with one such on-line electronic installment loan application 101. It will be obvious to those of ordinary skill in the art having the benefit of this disclosure that other applications will be equally well suited to embodiments of the invention, including on-line sales systems, on-line customer service systems, on-line search systems, and so forth.

FIG. 2 illustrates one embodiment of an on-line electronic loan application 101 presented on a client terminal 113. A lender employing a system in accordance with the invention may provide prospective borrowers with access to the on-line electronic loan application 101 over a network 114, such as the Internet. The prospective borrower uses a client browser portal, which in one embodiment is an Internet browser, to access the on-line electronic loan application 101.

The illustrative embodiment shown in FIG. 2 is that of an on-line electronic loan application 101 comprising a start page 200. The prospective borrower is first presented with the start page 200 upon accessing the electronic interface 106 through the network 114. The start page 200 may comprise a start pane 201 into which identification information is entered. Additionally, the start page 200 may also include company information 202 introducing the prospective borrower to the on-line lending company. The prospective borrower may need to provide at least one piece of personal identification information 203 before continuing to the actual on-line loan application. This personal identification information 203, in one embodiment, is transferred as a first portion of the customer transaction request to the electronic interface 106. The personal identification information 203 may include, but is not limited to, a name, an email address, or a user identification name.

The prospective borrower may be required to read and agree to a lender privacy policy 204. This may occur after the personal identification information 203 is entered, but before more of the on-line electronic loan application 101 is presented. Once the prospective borrower has both indicated that the lender privacy policy 204 has been read and has entered the personal identification information 203, the personal identification information 203 and the acceptance of the lender privacy policy 204 are then transmitted to the electronic interface 106 over the network 114.

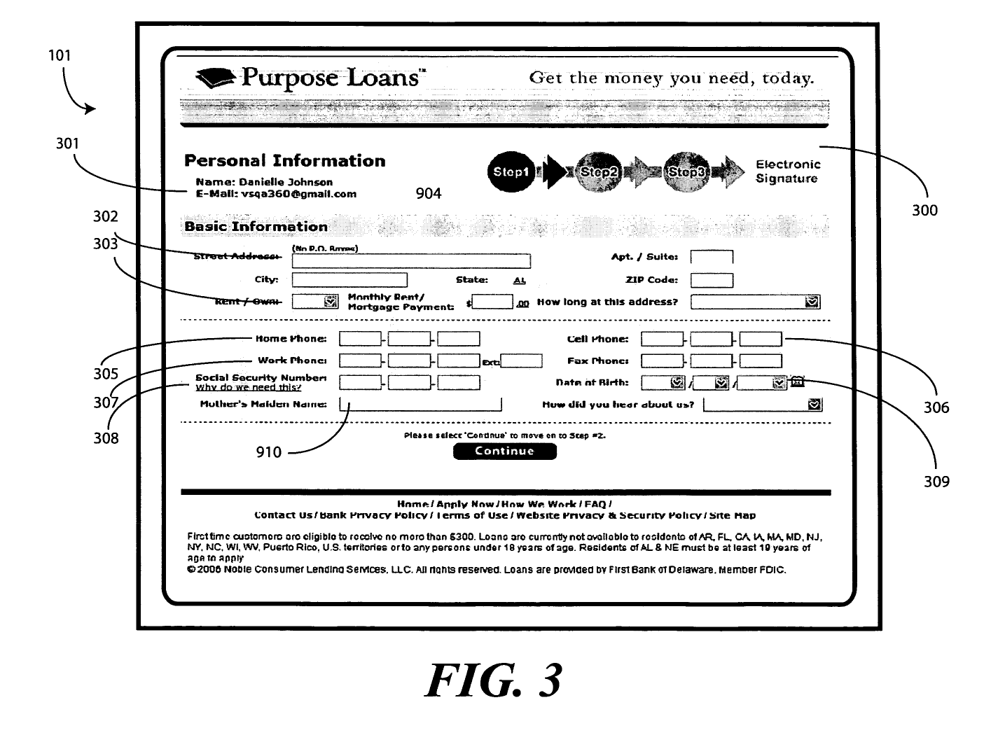

Turning now to FIG. 3, illustrated therein is a second screenshot associated with embodiments of the invention. As shown in FIG. 3, the exemplary on-line electronic loan application 101 includes a personal information request page 300 with which a prospective borrower is queried for additional personal information 301. The personal information request page 300 may be presented to the prospective borrower following the transmission of the personal identification information (203). In one embodiment, the requested personal information 301 includes the prospective borrower's home address 302, residential status (owner or renter) 303, amount of housing payments (mortgage or rent) 304, home telephone number 305, cell phone number 306, work phone number 307, social security number 308, date of birth 309, and mother's maiden name 310. The personal information 301 entered by the prospective borrower is then transmitted to the electronic interface (106).

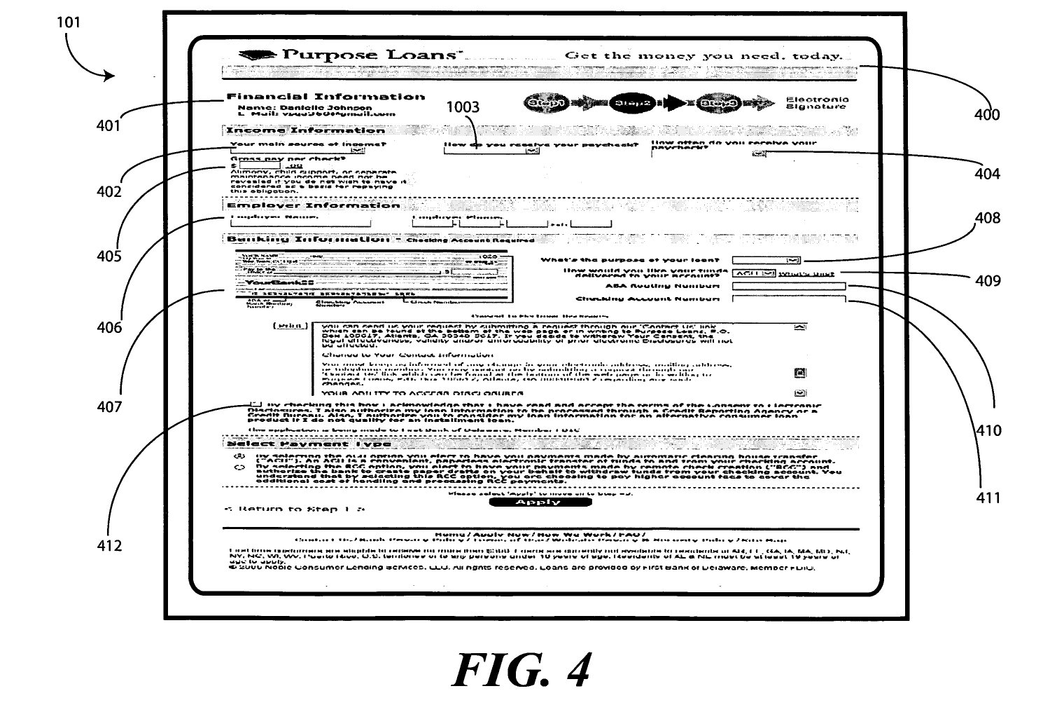

Turning to FIG. 4, illustrated therein is another screen shot from one embodiment of the electronic loan application in accordance with the invention. The screen shot of FIG. 4 includes a financial information request page 400 with which the prospective borrower is queried for financial information 401. The financial information request page 400 may be presented to the prospective borrower following submission of the personal information (301). In one embodiment, the financial information 401 is used by the system to determine whether to approve the prospective borrower, as well as whether to present a loan offer to the prospective borrower. The requested financial information 401 may include, but is not limited to, the prospective borrower's source of income 402, method of receiving paychecks 403, frequency of receiving paychecks 404, amount of paychecks 405, and employer information 406.

In one embodiment, the financial information 401 includes banking information 407. Providing banking information 407 may help expedite repayment of the loan through the electronic transfer of funds from a checking account. Additionally, electronic transfer of funds may reduce the overall cost of the loan to the prospective borrower. In one embodiment an Automatic Clearing House (ACH) is used to facilitate the repaying of the loan offer. Requested banking information may include: a purpose for the loan 408, a method for electronic transfer of funds 409, such as ACH or remote check creation, an American Banking Association (ABA) routing number 410, a checking account number 411, and an acknowledgement of having read terms and conditions 412 corresponding to consent of electronic disclosure.

The financial information 401 is then sent over the network (114) to the electronic interface (106). The system then works with the database (108) to store the data. The system then operates on the data, making decisions as to whether to offer the prospective borrower the loan.

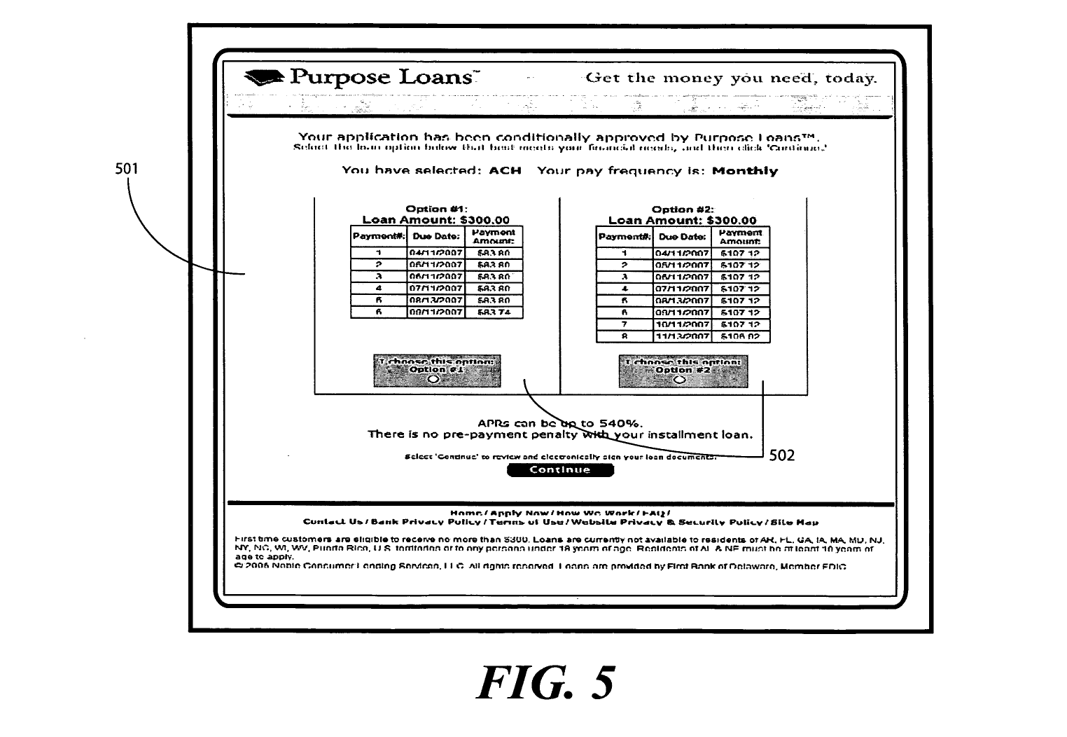

Turning to FIG. 5, illustrated therein is one embodiment of the one or more loan offers 501 presented, via the Network (114), to the user. Acceptance of either of these loan offers 501 forms the main subject of the customer transaction request in an on-line lending application. In the illustrative embodiment of FIG. 5, two different loan offers 502 are presented. While two loan offers 502 are shown, one, three, or four or more loan offers could equally be shown. Multiple loan offers may be presented when the prospective borrower has optional payment schedules. Additionally, multiple loan offers may be presented when the prospective borrower qualifies for differing loan amounts.

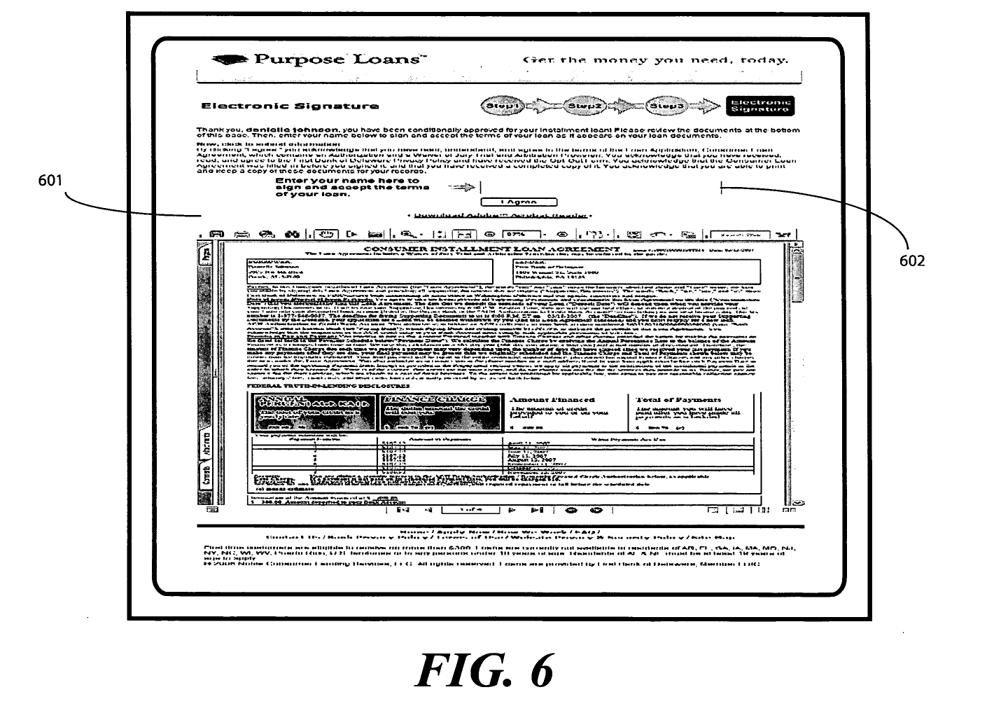

Turning now to FIG. 6, illustrated therein is one embodiment of an optional terms and conditions agreement 601 presented to the customer prior to completion of the customer transfer request. In one embodiment, a terms and conditions agreement 601 may be presented along with the one or more loan offers (502). The terms and conditions agreement 601 may, among other things, inform the prospective borrower about their fiscal responsibility upon accepting a loan offer. Such fiscal responsibility may include knowledge of annual percentage rates, finance charges, total amount financed, and amount of monthly payments. Privacy information and other processing information may additionally be presented.

In one embodiment, the terms and conditions agreement 601 includes a request 602 for the terms and conditions agreement 601 to be executed. Execution of the terms and conditions agreement 601 may be required before any one loan can be completed. Where the customer fails to execute the terms and conditions agreement 601, the customer transaction request comprises a partially completed on-line loan application. Such a partially completed loan application, where the terms and conditions agreement 601 is required, would necessitate customer service assistance.

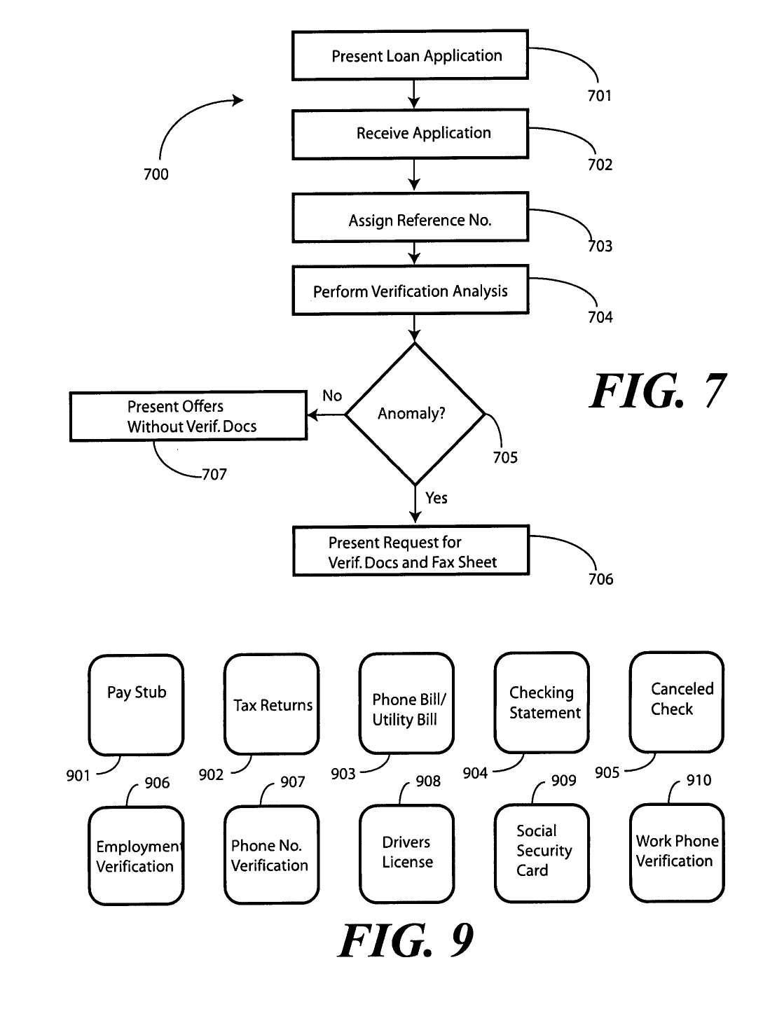

Turning now to FIG. 7, illustrated therein is one embodiment of a method 700 for on-line loan application completion in accordance with the invention. At step 701, the method 700 presents, electronically, over a network (114) on a client terminal (113) an on-line electronic loan application (101). At step 702, a partially completed on-line loan application (101) is received from the prospective borrower. In one embodiment, the on-line loan application comprises at least personal information, bank information, and financial information, as noted above in the discussion of FIGS. 2-6.

At step 703, there is an optional step of assigning a reference number to the partially completed on-line electronic loan application 101. This step is useful in tracking the on-line electronic loan application 101 and for recalling it from the database (108). Additionally, it may be employed in the generation of a barcode for the fax coversheet, where such a coversheet and barcode are employed.

At step 704, the method 700 performs verification analyses on extracted data from the on-line electronic loan application (101). The extracted data may be any of the personal information, bank information, or financial information, or combinations or subsets thereof. This verification analysis will be explained in more detail in the discussion of FIG. 8 below.

At decision 705, the method 700 determines whether an anomaly has occurred during the analysis. Where an anomaly has occurred, it may not mean that the prospective borrower will be denied the loan. Rather the prospective borrower may be requested to submit certain verification documentation to support reasons for the discrepancy, or to explain the anomaly. Where there is no anomaly, and where the prospective borrower is approved in accordance with the lenders loan approval criteria, loan offers are presented at step 707. However, where anomalies exist, the method 700 generates, electronically, over the network (114) on the client terminal (113), a prompt requesting verification documentation relating to the anomaly at step 706, which may be one with respect to the personal information, bank information, financial information, or combinations thereof. In one embodiment, a fax coversheet is delivered to the client terminal (113) at step 706 as well.

Turning briefly to FIG. 9, illustrated therein are exemplary types of verification documentation that may be required. These documents include a pay stub 901, tax returns 902, a phone bill or utility bill 903, a checking account statement 904, a canceled check 905, employment verification 906 (such as a worker or union identification card), home phone number verification 907, a drivers license 908, a social security card 909, and a work phone verification 910. Clearly, when submitting these documents to the lender by facsimile, copies would be suitable as verification documents.

Each verification document may demonstrate different information. For example, the phone bill or utility bill 903 will generally include the borrower's home address. It will be clear to those of ordinary skill in the art having the benefit of this disclosure that other types of verification documentation may also be requested. The documents of FIG. 9 are illustrative only.

Generally speaking, the employment paystub 901, the tax return 902, the phone bill or the utility bill 903, the drivers license 908, or the checking account statement 904 are suitable for demonstrating personal information. As such, when an anomaly with personal information is detected, the system (100) may deliver a prompt to the borrower requesting one of these documents as verification documentation. Similarly, the checking account statement 904 or the canceled check 905 relate to banking information. As such, when an anomaly with banking information is detected, the system (100) may deliver a prompt to the borrower requesting one of these documents as verification documentation. Likewise, the paystub 901, the tax return 902, and the checking account statement 904 relate to financial information. As such, when an anomaly with financial information is detected, the system (100) may deliver a prompt to the borrower requesting one of these documents as verification documentation.

The system may also analyze credit history information using the information retrieved from third party sources. To obtain this information, such as from a credit bureau system, the system may request the paystub 901, the tax return 902, the social security card 909, or the drivers license 908.

Turning now to FIG. 8, illustrated therein is one method of performing verification analysis 704 in accordance with embodiments of the invention. The verification analysis in FIG. 8 is exemplary only, as it will be clear to those of ordinary skill in the art having the benefit of this disclosure that numerous other methods can be used. Further, many lenders have proprietary systems for performing verification analysis on prospective borrowers. These methods could be used in place of the method of FIG. 8 while staying within the spirit of the invention and scope of the claims.

At step 801, the system checks customer history. The system may check customer history, for example, to determine whether the borrower is an existing customer or is new to the lender. In one embodiment, the system uses personal information, such as name and e-mail address, to determine whether the customer has an open account. If the prospective borrower is an existing client, i.e. has taken out other loans from the lender, the lender may also determine whether the customer has a voided account with a positive balance, whether any charge offs exist, how recently another loan was taken or repaid, how many loans have been taken out in the past, whether the same bank accounts are being used for the prospective loan as were used in past loans, whether the lender has ever declined credit to this customer, and if so why. The lender may have certain rules, such as if four loans have been given in the past 12 months, no new loan will be given. The lender passes or declines the prospective borrower, based upon customer history, at step 802. If the customer is declined, an adverse action letter is generated at step 813. The letter is delivered to the prospective borrower at step 814.

At step 803, the system checks to see whether the prospective borrower has any open loans. This may be done through third party services, such as Teletrack. Teletrack is a company that tracks non-traditional loan processing, and provides accumulated information to lenders. At step 803, the lender may query Teletrack to determine whether the person has any other open installment loans or whether there have been any charged off loans in the recent pass. The lender may pass or decline the prospective borrower, based upon open loan information, at decision 804.

At step 805, the system checks bank information. Again, this may be done in conjunction with information provided by a third party vendor. Such purveyors of banking information are companies like Accuity and Certegy. Accuity provides lenders with listings of all FDIC insured banking institutions and their company information, including routing numbers, addresses, phone numbers and the like. Certegy analyzes bank account routing numbers to determine whether electronic transactions, such as withdrawal payments to repay a loan, are acceptable. At step 805, the lender may determine whether the routing number provided by the prospective borrower is valid, and whether the account is suitable for electronic withdrawals.

At step 806, the system checks the prospective borrower's credit information. This may be done by querying a third part credit reporting bureau, such as Equifax, Experian, and Trans Union. The lender may analyze credit reports for adverse listings, such as loan defaults, late payments, and the like. The lender may pass or decline the prospective borrower, based upon credit information, at decision 807.

At step 808, the system checks personal history information. For example, the system may check whether the address provided by the prospective borrower is the same as the address listed on the credit report. Where it is not, an anomaly may be flagged.

At step 809, the lender's own financial modeling may be used. For instance, some lenders consider FICO scores, their own custom scores, bankruptcy indices, and so forth. The lender may pass or decline the prospective borrower, based upon personal history and modeling information information, at decision 810.

At any of these analysis steps, anomalies may be detected and verification documentation may be requested. For instance, at the credit check step, step 806, if a lender found a death date populated on a pulled credit report, the lender may desire to have the prospective borrower send in every verification document of FIG. 9 to ensure that the death date is an error. Similarly, if the lender discovers that there is an address mismatch, the lender may require a phone bill or utility bill as a verification document. If the prospective borrower is a new customer, the system may desire to obtain banking and employment information. The system may require a bank account statement and a paystub as verification documentation. Other tests may be used in the process of validation, each rendering a different validation document to be submitted when anomalies are detected.

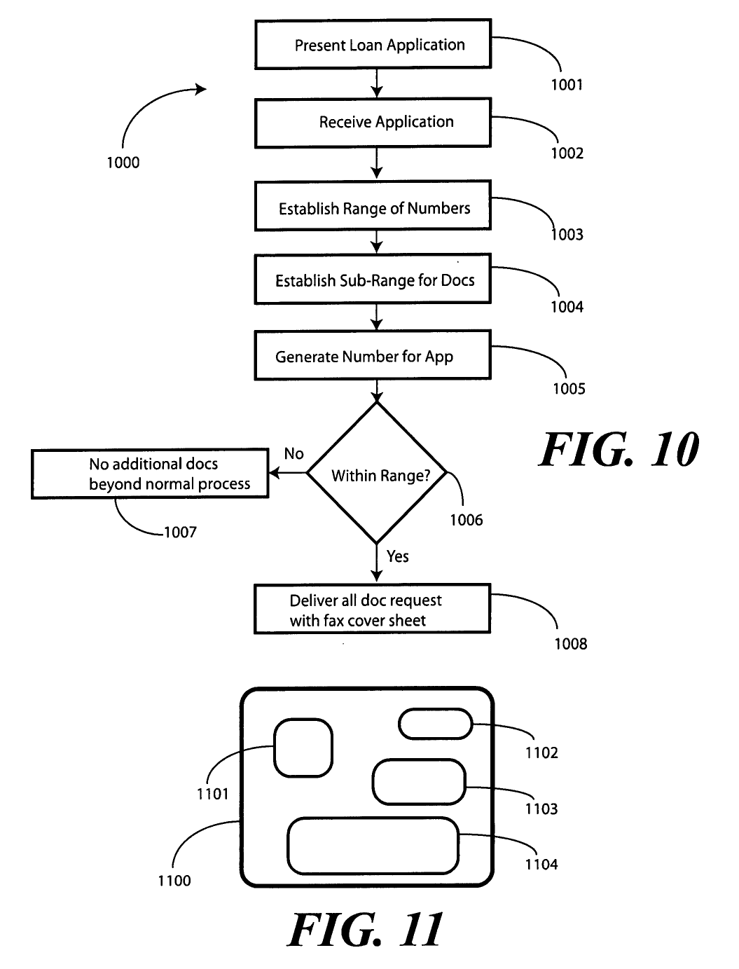

Turning now to FIG. 10, illustrated therein is an alternate method 1000 for on-line loan application completion in accordance with embodiments of the invention. The method 1000 of FIG. 10 may be used for control of loan backlog, inflow, and approval. In the method 1000 of FIG. 10, essentially every application that is received with a certain criterion is flagged as having an anomaly. As such, verification documentation is required. As people are less likely to obtain loans when a large number of verification documents are required—simply because some will not go to the effort of gathering the verification documents—assigning anomalies in such a manner works as a suitable method to limit the inflow of on-line loan applications.

At step 1001, the on-line electronic loan application (101) is presented on the client terminal (113). At step 1002, a partially completed on-line loan application is received. At step 1003, a range of numbers is established and stored in the database (108). As an example for the purposes of discussion, a range of 1 to 100 may be established at step 1003.

At step 1004, a sub-range of the numbers is established. For discussion, suppose the sub-range is 60 to 85. This sub-range is then stored in the database (108). At step 1005, a number is generated and assigned to the on-line electronic loan application (101). This number could be a random number, within the predetermined range, generated by a random number generator. This number may be a sequential number within the predetermined range. Other algorithms may also be used. Once the number is assigned, it is written to the database (108) and is associated with a particular on-line electronic loan application (101).

At decision 1006, the method 1000 determines whether the number generated is within the sub-range. If it is, a predetermined number of verification documents are required. In one embodiment, all the documents of FIG. 8 are required, as is shown at step 1008. This “kitchen sink” requirement reduces the inflow of completed applications, which under certain staffing or financial constraints, may be beneficial. A fax coversheet may also be delivered at step 1008.

Turning now to FIG. 11, illustrated therein is one exemplary fax coversheet 1100 in accordance with embodiments of the invention. The fax coversheet 1100 may include borrower information 1101, such as the borrower's name, address, and telephone number. The fax coversheet 1100 may also include lender information 1103, such as lender name, address, and fax number. The fax coversheet 1100 may also include a listing of verification documents 1104 that is preprinted so the prospective borrower understands which documents are required. The fax coversheet 1100 may also include a barcode 1102, as mentioned above, to facilitate electronic routing of the incoming documents and association with the proper on-line loan application (101).

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for on-line loan application completion, the method comprising the steps of:
presenting, electronically, over a network on a client terminal an on-line loan application;
receiving at least a partially completed on-line loan application from a prospective borrower, the on-line loan application comprising at least personal information, bank information, and financial information;
assigning a reference number to the at least a partially completed loan application;
performing verification analysis on one of the personal information, bank information, or financial information;
detecting at least one anomaly with the one of the personal information, bank information, or financial information;
generating, electronically, over the network on the client terminal, a prompt requesting verification documentation relating to the one of the personal information, bank information, or financial information; and
delivering a fax coversheet to the client terminal, the fax cover sheet comprising an indication of the verification documentation.

2. The method of claim 1, wherein the fax coversheet further comprises a bar code associated with the reference number.

3. The method of claim 1, wherein the anomaly comprises one of an invalid bank routing number or an invalid home address.

4. The method of claim 1, wherein the step of performing verification analysis comprises verifying the personal information, wherein the step of generating the prompt requesting verification documentation comprises requesting one of an employment paystub, a tax return, a phone bill, a utility bill, a driver's license, or a checking account statement.

5. The method of claim 1, wherein the step of performing verification analysis comprises verifying the bank information, wherein the step of generating the prompt requesting verification documentation comprises requesting one of a checking account statement or a canceled check.

6. The method of claim 1, wherein the step of performing verification analysis comprises verifying the financial information, wherein the step of generating the prompt requesting verification documentation comprises requesting one of a paystub, a tax return, or a checking account statement.

7. The method of claim 1, wherein the step of performing verification analysis comprises verifying credit history information by querying a credit bureau system, wherein the step of generating the prompt requesting verification documentation comprises requesting one of a paystub, a tax return, a social security card, or a drivers license.

8. The method of claim 1, wherein the step of presenting, electronically, over a network on a client terminal an on-line loan application comprises presenting a start page, presenting a personal information request page, a financial information request page, one or more loan offers, and a terms and conditions agreement.

9. The method of claim 1, further comprising the step of receiving a facsimile transmission comprising the fax coversheet and the verification documentation.

10. A method for on-line loan application completion, the method comprising the steps of:
presenting, electronically, over a network on a client terminal an on-line loan application;
receiving at least a partially completed on-line loan application from a prospective borrower, the on-line loan application comprising at least personal information, bank information, and financial information;
establishing a predetermined range of numbers;
defining a sub-range of numbers from the predetermined range;
generating a number within the predetermined range;
associating the number with the at least a partially completed on-line loan application;
comparing the number to the sub-range;
wherein the number is within the sub-range, generating, electronically, over the network on the client terminal a prompt requesting verification documentation relating to the each of the personal information, bank information, and financial information; and
delivering a fax coversheet to the client terminal, the fax cover sheet comprising an indication of the verification documentation.

11. The method of claim 10, wherein the verification documentation comprises at least three of a paystub, a tax return, a phone bill, a utility bill, a checking account statement, a canceled check, a primary phone number verification, a drivers license, a social security card, an employment verification, or a work phone number verification.

12. The method of claim 11, wherein the verification documentation comprises five or more of the paystub, the tax return, the phone bill, the utility bill, the checking account statement, the canceled check, the primary phone number verification, the drivers license, the social security card, the employment verification, or the work phone number verification.

13. A system for use in completing on-line electronic loan application processes, configured for operation across a network between a server and a client terminal, the system comprising:
an electronic interface coupled with the server and configured to deliver the on-line electronic loan application to the client terminal, wherein the electronic interface is further configured to receive at least a partially completed on-line loan electronic application from the client terminal,
an analyzer, operable with the server, and configured to perform a verification analysis on data extracted from the partially completed on-line electronic loan application;
a request generator, operable with the server, and configured to deliver, electronically, over the network on the client terminal, a prompt requesting verification documentation relating to the extracted data; and
a document generation utility, operable with the server, configured to delivering a fax coversheet to the client terminal, the fax cover sheet comprising an indication of the verification documentation.

14. The system of claim 13, wherein the on-line electronic loan comprises a request for personal information, bank information, and financial information.

15. The system of claim 1, further comprising a database coupled to the server for storing on-line electronic loan application data, further comprising a facsimile transmission receiver, operable with the server, configured to receive facsimile transmissions, convert the facsimile transmissions to electronic documents, and to write the electronic documents to the database.

16. The system of claim 13, wherein the fax cover sheet further comprises a barcode.

17. The system of claim 16, further comprising a facsimile transmission receiver, operable with the server, configured to receive facsimile transmissions, convert the facsimile transmissions to electronic documents, and to write the electronic documents to the database using the barcode as a sorting criterion.

18. The system of claim 13, wherein the on-line electronic loan application comprises an on-line installment loan application.
